(19) United States
(12) Patent Application Publication
(10) Pub. No.: US 2026/0037053 A1
(43) Pub. Date: Feb. 5, 2026

(54) APPARATUSES AND METHODS FOR MULTIPLE POWER DOWN AND EXIT MODES IN MEMORY DEVICES

(71) Applicant: Micron Technology, Inc., Boise, ID (US)

(72) Inventors: Ming-Bo Liu, Boise, ID (US); Gary Howe, Boise, ID (US); David Brown, Boise, ID (US); Parthasarathy Gajapathy, Boise, ID (US)

(73) Assignee: Micron Technology, Inc., Boise, ID (US)

(21) Appl. No.: 19/283,750

(22) Filed: Jul. 29, 2025

Related U.S. Application Data
(60) Provisional application No. 63/677,859, filed on Jul. 31, 2024.

(51) Int. Cl. G06F 1/3296; G06F 1/3234

(52) U.S. Cl. CPC G06F 1/3296; G06F 1/3278

(57) ABSTRACT

A memory device can operate in multiple powerdown modes. A first powerdown mode powers down a memory rank by powering down one or more command address (CA) input buffers completely (e.g., turn off). A second powerdown mode powers down a memory rank by powering down one or more command address (CA) input buffers incompletely (e.g., a reduced operational state). In a non-limiting nonexclusive embodiment, the second powerdown mode powers down the one or more CA input buffers by placing the one or more CA input buffers in a low bias current state.

### CROSS-REFERENCE TO RELATED APPLICATION

This application claims the filing benefit of U.S. Provisional Application No. 63/677,859, filed Jul. 31, 2024. This application is incorporated by reference herein in its entirety and for all purposes.

### BACKGROUND

A semiconductor memory device may include a number of memory cells which are used to store data represented by binary digits (or “bits”). The memory cells are typically arranged in an array and the memory cells are accessed based on row addresses and column addresses. The semiconductor memory device can also include a number of input buffers, such as command and address (CA) input buffers that are used to receive commands and addresses. When a group of memory cells will not be accessed, one or more of the input buffers may be powered down to reduce the power consumption of the semiconductor memory device. The input buffers are activated when the group of memory cells will be accessed. In some instances, the amount of time the input buffers need to exit power down and be fully operational can be relatively long, which may adversely impact the performance of the semiconductor memory device.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the Figures.

FIG. 1 illustrates a block diagram of an example system according to an embodiment of the disclosure;

FIG. 2 illustrates a block diagram of certain features of an example semiconductor device according to an embodiment of the disclosure;

FIG. 3 illustrates a block diagram of certain features of an example memory module according to an embodiment of the disclosure;

FIG. 4 illustrates a block diagram of certain features of an example command address input circuit according to an embodiment of the disclosure;

FIG. 5 illustrates a schematic diagram of an example command address input buffer according to an embodiment of the disclosure;

FIG. 6 illustrates a schematic diagram of an example implementation of the variable bias current control circuit shown in FIG. 5 according to an embodiment of the disclosure;

FIG. 7 illustrates an example timing diagram for a slow powerdown exit according to an embodiment of the disclosure;

FIG. 8 illustrates an example timing diagram for a fast powerdown exit according to an embodiment of the disclosure;

FIG. 9 illustrates a table that lists characteristics of an active mode, a power down mode with a fast powerdown exit, and a power down mode with a slow powerdown exit for an input buffer according to an embodiment of the disclosure;

FIG. 10 illustrates a process flow diagram for a power down entry command and a power down exit command according to an embodiment of the disclosure;

FIG. 11 illustrates a first timing diagram for a power down entry command and a fast power down exit according to an embodiment of the disclosure;

FIG. 12 illustrates a second timing diagram for a power down entry command and a fast power down exit according to an embodiment of the disclosure; and

FIG. 13 illustrates a flowchart of an example method of operating a memory device according to an embodiment of the disclosure.

### DETAILED DESCRIPTION

In some embodiments, a system can include multiple memory devices or dies. Some or all of the memory devices may be configured on a memory module, and a system may include one or more memory modules. A memory rank refers to the one or more memory devices on a memory module. Each memory rank is connected to a distinct chip select signal line, and the memory device(s) in a memory rank share the chip select signal. The memory ranks receive the same command, address, data, and control information. During operation, the system can switch between the memory ranks to access different memory devices. When a particular memory rank is to be accessed, that memory rank is selected and activated and the unselected or inactive memory rank(s) are typically powered down to reduce the overall power consumption of the system. When an inactive memory rank is to be accessed, the currently active memory rank is powered down and the inactive memory rank exits power down. As used herein, “powered down”, “power down”, “powering down”, and “powers down” cover components (e.g., circuits) being turned off completely as well as a reduced operation where the components are not turned off completely but operate at a reduced level and/or provide a reduced output.

Embodiments described herein provide systems and methods for enabling a memory device to operate in multiple powerdown modes. A first powerdown mode powers down a memory device and enables a first powerdown exit to exit power down. A second powerdown mode powers down a memory device differently from the first powerdown and enables a different second powerdown exit to exit power down. In a non-limiting nonexclusive embodiment, the first powerdown mode powers down components completely and exits power down in a relatively slow powerdown exit. The second powerdown mode powers down components incompletely (e.g., a reduced operational state) and exits power down in a relatively fast powerdown exit. The fast powerdown exit uses less time to exit power down compared to the slow powerdown exit.

In one embodiment, the first powerdown mode powers down input buffers completely (i.e., turned off), and the second powerdown mode powers down input buffers incompletely (e.g., a reduced operational state). When exiting the first powerdown mode in the slow powerdown exit, input buffers power up from complete power down to a full operation state. When exiting the second powerdown mode in the fast powerdown exit, input buffers power up from incomplete power down to a full operation state. The first powerdown exit executes over a first time period and the second powerdown exit executes over a second time period that is shorter than the first time period. The power consumption of a system is reduced with both the first powerdown mode and the second powerdown mode, but power consumption may be reduced more with the first powerdown mode compared to the second powerdown mode. In some instances, a trade off may exist between the amount of power consumption that is reduced and the amount of time needed to exit power down.

In one embodiment, the input buffers are CA input buffers in the inactive memory rank(s). In the first powerdown mode, the CA input buffers are powered down completely (e.g., turned off) and in the second powerdown mode, the CA input buffers are powered down incompletely (e.g., a low operational state by putting the CA input buffers into a low bias current state). In the second powerdown mode, the bias current in the CA input buffers is reduced but is not zero, which enables the CA input buffers to exit power down relatively faster than the powerdown exit time in the first powerdown mode. When CA input buffers of an inactive memory rank are in the low bias state, power consumption is lower compared to an active state of a memory rank but power consumption is higher than when the CA input buffers are powered down completely (i.e., as in the first powerdown mode).

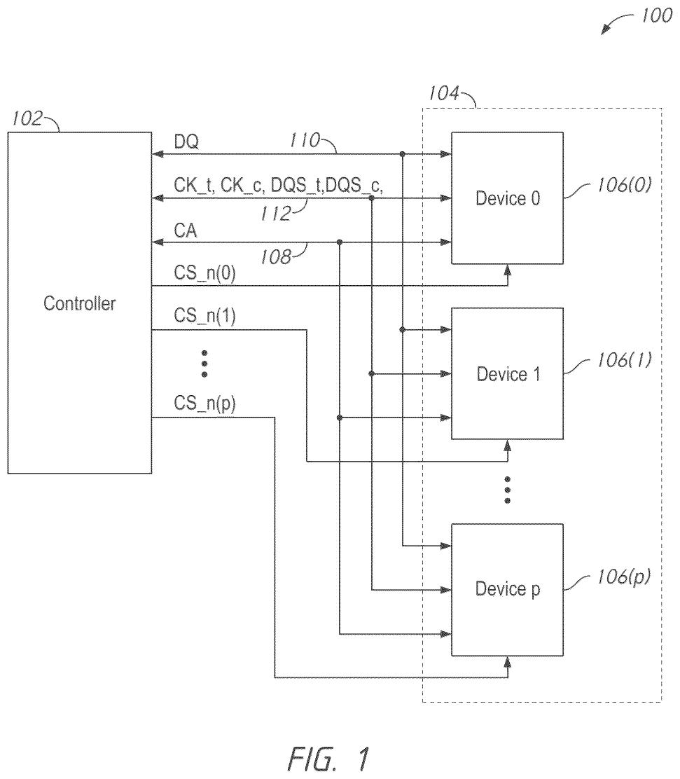

The powerdown mode to be used for inactive memory ranks can be indicated by a controller (e.g., the controller 102 of FIG. 1) in one of several ways. In one embodiment, a separate command can be provided by the controller to indicate which powerdown mode is to be used. In another embodiment, a power down entry (PDE) command can include one or more bits that are used to indicate which powerdown mode is to be used. For example, one or more CA bits in the PDE command may be used to indicate which powerdown mode is to be used.

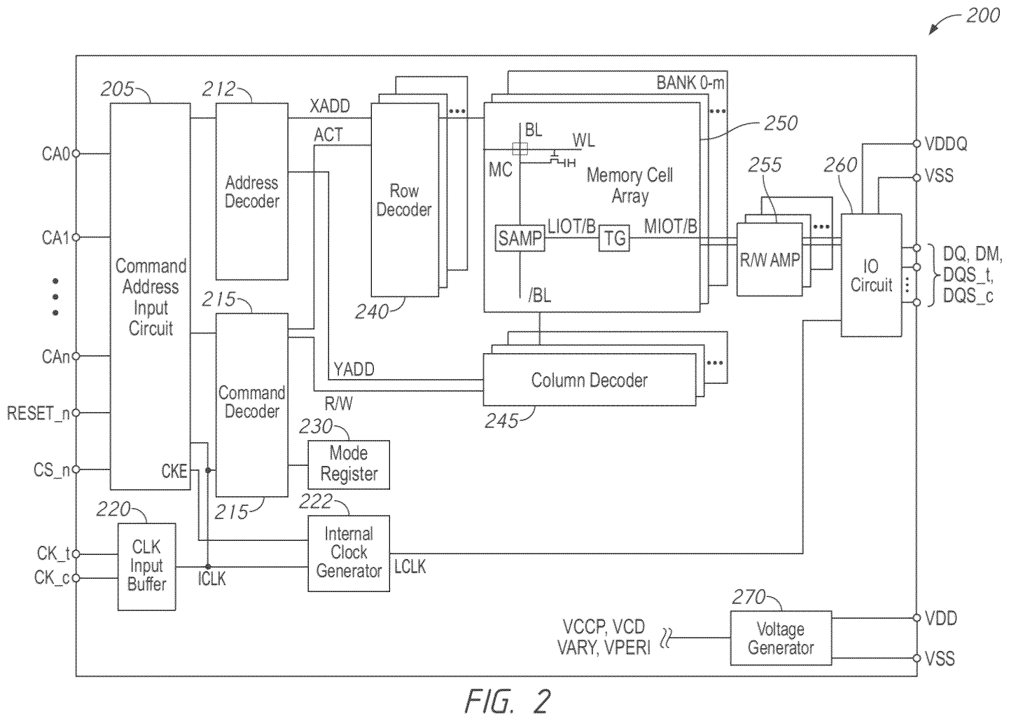

In other embodiments, a setting of a mode register may be used to indicate which powerdown mode is to be used (e.g., the mode register 230 of FIG. 2). In one embodiment, a bit of a mode register may be set to indicate all powerdown modes are to be executed in one mode of the powerdown modes (e.g., the second powerdown mode with the fast powerdown exit). In such embodiments, the other mode of the powerdown modes (e.g., the powerdown mode with the slow powerdown exit) is not available. In another embodiment, the mode register can be modified (e.g., reset) to switch between one powerdown mode to the other powerdown mode during operation of a memory device.

FIG. 1 illustrates a block diagram of an example system 100 according to an embodiment of the disclosure. The system 100 includes a controller 102 and a memory system 104. In the illustrated embodiment, the memory system 104 includes memory devices 106(0)-106(p) (e.g., “Device 0” through “Device p”), where p is a number greater than zero (0).

In one embodiment, the memory system 104 is a memory module and the memory devices 106(0)-106(p) are memory ranks. The memory devices 106(0)-106(p) may include a dynamic random-access memory (DRAM), a double data rate (DDR) memory, a low power double data rate (LPDDR) memory, a graphics double data rate (GDDR) memory, or other type of memory. Each memory rank can include one or more memory dies (e.g., DRAM dies).

The memory devices 106(0)-106(p) are each coupled to the command/address, data, and clock busses. The controller 102 and the memory system 104 are in communication over several busses. Commands and addresses (CA) are received by the memory system 104 on a command/address bus 108, and data is provided between the controller 100 and the memory system 104 over a data bus (DQ) 110. Various clocks may be provided between the controller 100 and the memory system 104 over a clock bus 112. The clock bus 112 may include signal lines for providing system clocks CK_t and CK_c received by the memory system 104 and data clocks (strobes) DQS_t and DQS_c received and/or provided by the memory system 104 to the controller 100. Each of the busses may include one or more signal lines on which signals are provided.

The CK_t and CK_c clocks provided by the controller 102 to the memory system 104 are used for timing the provision and receipt of the commands and addresses. The DQS_t and DQS_c clocks are used for timing the provision of data. The CK_t and CK_c clocks are complementary, and the DQS_t and DQS_c clocks are complementary. Clocks are complementary when a rising edge of a first clock occurs at a same time as a falling edge of a second clock, and when a rising edge of the second clock occurs at a same time as a falling edge of the first clock.

The controller 102 provides commands to the memory system 104 to perform memory operations. Examples of memory commands include timing commands for controlling the timing of various operations, access commands for accessing the memory, such as read commands for performing read operations and write commands for performing write operations, as well as other commands and operations. The command signals provided by the controller 102 to the memory system 104 further include external control signals (e.g., CS_n(0), CS_n(1), CS_n(p)). All of the memory devices 106(0)-106(p) are provided the commands, addresses, data, and clocks, and the external control signals provided on respective select signal lines are used to select which of the memory devices 106(0)-106(p) will respond to the command and perform the corresponding operation. In some embodiments, a respective control signal is provided to each memory device 106(0)-106(p) of the memory system 104. The controller 102 provides an active control signal to select the corresponding memory device 106(0)-106(p). While the respective control signal is active, the corresponding memory device 106(0)-106(p) is selected to receive the commands and addresses provided on the command/address bus 108. In some embodiments, the external control signal is used in combination with the CA signals to indicate different memory commands and memory operations.

In operation, when a read command and associated address are provided by the controller 102 to the memory system 104, the memory device 106(0)-106(p) selected by the external control signals receives the read command and associated address, and performs a read operation to provide the controller 102 with read data from a memory location corresponding to the associated address. The read data is provided by the selected memory device 106(0)-106(p) to the controller 102 according to a timing relative to receipt of the read command. For example, the timing may be based on a read latency (RL) value that indicates the number of clock cycles of the CK_t and CK_c clocks (a clock cycle of the CK_t and CK_c clocks is referenced as tCK) after the read command when the read data is provided by the selected memory device 106(0)-106(p) to the controller 102. The RL value is programmed by the controller 102 in the memory devices 106(0)-106(p). For example, the RL value may be programmed in respective mode registers of the memory devices 106(0)-106(p). As known, mode registers included in each of the memory devices 106(0)-106(p) may be programmed with information for setting various operating modes and/or to select features for operation of the memory devices 106(0)-106(p). One of the settings may be for the RL value.

In preparation of the selected memory device 106(0)-106(p) providing the read data to the controller 102, the memory device provides active data clocks DQS_t and DQS_c. A clock is active when the clock transitions between low and high clock levels periodically. Conversely, a clock is inactive when the clock maintains a constant clock level and does not transition periodically. The DQS_t and DQS_c clocks are provided by the memory device 106(0)-106(p) performing the read operation to the controller 102 for timing the provision of read data to the controller 102. The controller 102 may use the DQS_t and DQS_c clocks for receiving the read data.

In operation, when a write command and associated address are provided by the controller 102 to the memory system 104, the memory device 106(0)-106(p) selected by the external control signals receives the write command and associated address, and performs a write operation to write data from the controller 102 to a memory location corresponding to the associated address. The write data is provided to the selected memory device 106(0)-106(p) by the controller 102 according to a timing relative to receipt of the write command. For example, the timing may be based on a write latency (WL) value that indicates the number of clock cycles of the CK_t and CK_c clocks after the write command when the write data is provided to the selected memory device 106(0)-106(p) by the controller 102. The WL value is programmed by the controller 102 in the memory devices 106(0)-106(p). For example, the WL value may be programmed in respective mode registers of the memory devices 106(0)-106(p).

In preparation of the selected memory device 106(0)-106(p) receiving the write data from the controller 102, the controller 102 provides active data clocks DQS_t and DQS_c to the memory system 104. The DQS_t and DQS_c clocks may be used by the selected memory device 106(0)-106(p) to generate internal clocks for timing the operation of circuits to receive the write data. The data is provided by the controller 102 and the selected memory device 106(0)-106(p) receives the write data according to the DQS_t and DQS_c clocks, which is written to a memory location corresponding to the memory address.

Mode register write commands and mode register read commands can be used to access the mode registers (e.g., mode register 230 in FIG. 2). In operation, when a mode register read command and associated address are provided by the controller 102 to the memory system 104, the memory device selected by the select signals receives the read command and associated address and performs a mode register read operation to provide the controller 102 with data from the mode register corresponding to the associated address. The data is provided by the selected mode register to the controller 102. When a mode register write command and associated address are provided by the controller 102 to the memory system 104, the memory device selected by the select signals receives the write command and associated address and performs a write operation to write data from the controller 102 to a mode register corresponding to the associated address. The data is provided to the selected mode register by the controller 102.

FIG. 2 illustrates a block diagram of a semiconductor device according to an embodiment of the disclosure. The semiconductor device 200 may include, without limitation, a memory such as a DRAM. In one embodiment, one or more semiconductor devices 200 are included in a memory rank.

The semiconductor device 200 includes a memory array 250. The memory array 250 is shown as including a plurality of memory banks. In the embodiment of FIG. 2, the memory array 250 is shown as including memory banks BANK0-BANKm. Each memory bank includes a plurality of word lines WL, a plurality of bit lines BL and/BL, and a plurality of memory cells MC arranged at intersections of the plurality of word lines WL and the plurality of bit lines BL and/BL. Selection of the word line WL is performed by a row decoder 240 and selection of the bit lines BL and/BL is performed by a column decoder 245. In the embodiment of FIG. 2, the row decoder 240 includes a respective row decoder for each memory bank and the column decoder 245 includes a respective column decoder for each memory bank. The bit lines BL and/BL are coupled to a respective sense amplifier (SAMP). Read data from the bit line BL or/BL is amplified by the sense amplifier SAMP and transferred to read/write amplifiers 255 over complementary local data lines (LIOT/B), transfer gate (TG), and complementary main data lines (MIOT/B). Conversely, write data output from the read/write amplifiers 255 is transferred to the sense amplifier SAMP over the complementary main data lines MIOT/B, the transfer gate TG, and the complementary local data lines LIOT/B, and written in the memory cell MC coupled to the bit line BL or/BL.

A mode register 230 stores information, for example, configuration and status information for the semiconductor device 200. In some embodiments, the mode register 230 stores information that indicates whether the semiconductor device 200 will execute the first powerdown mode with the slow powerdown exit or the second powerdown mode with the fast powerdown exit. The first and the second powerdown modes are described in more detail later.

The mode register 230 may be accessed through mode register read commands and mode register write commands. The mode register access commands cause the semiconductor device 200 to perform mode register read operations and mode register write operations. A mode register read command causes the semiconductor device 200 to provide information stored by the mode register that is accessed, and a mode register write command causes the semiconductor device 200 to store information in the mode register that is accessed. The mode register 230 may include several mode registers, with each of the mode registers corresponding to a mode register address and storing different types of information.

The semiconductor device 200 may employ a plurality of external terminals that include command and address (CA) and control terminals (Reset_n and CS_n) coupled to a command and address bus to receive commands and addresses, an external reset_n signal and an external control CS_n signal. The external terminals may further include clock terminals to receive clocks CK_t and CK_c, and data clocks DQS_t and DQS_c, data terminals DQ and DM, and power supply terminals to receive power supply potentials VDD, VSS, and VDDQ.

The clock terminals are supplied with external clocks CK_t and CK_c that are provided to a CLK input buffer 220. The external clocks may be complementary. The CLK input buffer 220 generates an internal clock ICLK based on the CK_t and CK_c clocks. The ICLK clock is provided to the command decoder 215 and to an internal clock generator 222. The internal clock generator 222 provides various internal clocks LCLK based on the ICLK clock. The LCLK clocks may be used for timing operation of various internal circuits.

The CA terminals (e.g., CA0-CAn) may be supplied with commands and memory addresses. The command/address (CA) input circuit 205 includes CA input buffers that receive command and address signals for the commands and memory addresses. The memory addresses supplied to the CA terminals are transferred, via the CA input circuit 205, to an address decoder 212. The address decoder 212 receives the address and supplies a decoded row address XADD to the row decoder 240 and supplies a decoded column address YADD to the column decoder 245. The CA terminals may be supplied with commands. Examples of commands include access commands for accessing the memory, such as read commands for performing read operations and write commands for performing write operations, mode register write and read commands for performing mode register write and read operations, power down entry commands, activation commands, power down exit commands, as well as other commands and operations.

The commands may be provided as internal command signals to a command decoder 215 via the CA input circuit 205. The command decoder 215 includes circuits to decode the internal command signals to generate various internal signals and commands for performing operations. For example, the command decoder 215 may provide a row command signal ACT to select a word line and a column command signal R/W to select a bit line.

The power supply terminals are supplied with power supply potentials VDD and VSS. The power supply potentials VDD and VSS are supplied to an internal voltage generator circuit 270. The internal voltage generator circuit 270 generates various internal potentials VCCP, VOD, VARY, VPERI, and the like based on the power supply potentials VDD and VSS supplied to the power supply terminals. The internal potential VCCP is mainly used in the row decoder 240, the internal potentials VOD and VARY are mainly used in the sense amplifiers SAMP included in the memory array 250, and the internal potential VPERI is used in many peripheral circuit blocks.

The power supply terminals are also supplied with power supply potentials VDDQ and VSS. The power supply potentials VDDQ and VSS are supplied to the input/output circuit 260. The power supply potentials VDDQ and VSS supplied to the power supply terminals may be the same potentials as the power supply potentials VDD and VSS supplied to the power supply terminals in an embodiment of the disclosure. The power supply potentials VDDQ and VSS supplied to the power supply terminals may be different potentials from the power supply potentials VDD and VSS supplied to the power supply terminals in another embodiment of the disclosure. The power supply potentials VDDQ and VSS supplied to the power supply terminals are used for the input/output circuit 260 so that power supply noise generated by the input/output circuit 260 does not propagate to the other circuit blocks.

Read data is read from a memory cell in the memory array 250 corresponding to a row address and a column address when a read command is received and the row address and the column address are timely supplied with an ACT command and/or the read command. The read command is received by the command decoder 215, which provides internal commands so that read data from the memory array 250 is provided to the read/write amplifiers 255. The read data is output to outside from the data terminals DQ via the input/output circuit 260. The DQS_t and DQS_c clocks are provided externally from clock terminals for timing provision of the read data by the input/output circuit 260. The external terminals DQ include several separate terminals, each providing a bit of data synchronized with a clock edge of the DQS_t and DQS_c clocks.

Write data supplied to the data terminals DQ is written to a memory cell in the memory array 250 corresponding to a row address and a column address when a write command is received and the row address and the column address are timely supplied with an ACT command and/or the write command. A data mask may be provided to the data terminals DM to mask portions of the data when written to memory. The write command is received by the command decoder 215, which provides internal commands so that the write data is received by input receivers in the input/output circuit 260. DQS_t and DQS_c clocks are also provided to the external clock terminals (e.g., by a controller) for timing the receipt of the write data by the input receivers of the input/output circuit 260. The write data is supplied via the input/output circuit 260 to the read/write amplifiers 255, and by the read/write amplifiers 255 to the memory array 250 to be written into the memory cell MC. As previously described, the external terminals DQ include several separate terminals. With reference to a write operation, each external terminal DQ concurrently receives a bit of data synchronized with a clock edge of the DQS_t and DQS_c clocks.

When a mode register read command is received, and a mode register address is timely supplied with the mode register read command, read information is read from the mode register 230 corresponding to the mode register address. The read information is output to outside from the data terminals DQ via the input/output circuit 260. When a mode register write command is received, and a mode register address is timely supplied with the mode register write command, write information supplied to the data terminals DQ is written to the mode register 230 corresponding to the mode register address.

When a PDE command is received, and the chip select signal CS_n is at an active signal level (e.g., a low or “0”), CA input buffers in the CA input circuit 205 are powered down to reduce power consumption. For example, CA input buffers in the CA input circuit 205 that are associated with one or more inactive memory ranks may be powered down by a PDE command. As will be described in more detail later, the CA input buffers may enter power down in a first powerdown mode or a second powerdown mode. The PDE command is received by the command decoder 215, which provides internal commands to cause CA input buffers in the CA input circuit 205 that are associated with one or more inactive memory ranks to power down.

When a power down exit (PDX) command is received, and the chip select signal CS_n is at an active signal level (e.g., a low or “0”), CA input buffers in the CA input circuit 205 exit power down and are activated in preparation to receive commands and addresses. For example, CA input buffers in the CA input circuit 205 that are associated with a formerly inactive memory rank exit power down and are activated. As will be described in more detail later, the CA input buffers may exit power down in a fast powerdown exit mode (when powered down in the second powerdown mode) or a slow powerdown exit mode (when powered down in the first powerdown mode). The PDX command is received by the command decoder 215, which provides internal commands to cause CA input buffers in the CA input circuit 205 that are associated with the formerly inactive memory rank to exit power down.

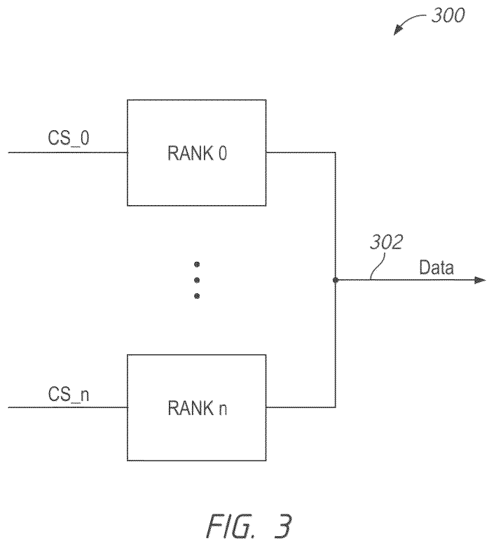

FIG. 3 illustrates a block diagram of certain features of an example memory module 300 according to an embodiment of the disclosure. A memory module can include one or more memory ranks. In the illustrated embodiment, the memory module 300 includes “n” memory ranks, where n is a number greater than or equal to one (i.e., n+1 memory ranks). Each memory rank may include one or more memory devices. Each memory rank is connected to a distinct chip select (CS_n) signal line and the output of each memory rank is connected to a data bus 302. For example, the memory devices of a memory rank may be connected to a common CS_n signal line and to the data bus 302. Which memory rank is able to transmit or receive data on the data bus 302 is controlled by a respective chip select signal. For example, when the memory rank 0 is to receive or output data, the chip select signal (CS_0) provided to the memory rank 0 transitions to an active signal level (e.g., a low or “0” state) and the remaining chip select signals are set to an inactive signal level (e.g., a high or “1” state). When data is to be input or output from another memory rank, the chip select signal provided to that memory rank transitions to an active signal level (e.g., a low or “0” state) and the chip select signal provided to the memory rank 0 (as well as any other chip select signals) is set to an inactive signal level (e.g., a high or “1” state). In this manner, a memory device can control which memory rank is transmitting or receiving data on the data bus 302.

During the operation of a memory module (e.g., a memory module with two or more ranks), CA input buffers in the memory rank(s) that are not accessed may be powered down to reduce the power consumption of a system. A PDE command is transmitted from a controller (e.g., the controller 102 of FIG. 1) to power down a non-accessed or inactive memory rank. In one embodiment, the PDE command causes CA input buffers associated with the inactive memory rank(s) to power down. The CA input buffers can power down completely (in the first powerdown mode) or incompletely (in the second powerdown mode). When an inactive memory rank is going to be accessed, the controller may transmit a PDX command to the inactive memory rank, which causes the inactive memory rank to become active and causes CA input buffers associated with that memory rank to exit power down. In some instances, the amount of time needed by the CA input buffers to charge up and operate fully can be relatively long. For example, with a double data rate 5 synchronous dynamic random-access memory (DDR5 DRAM), the amount of time between receipt of the power down exit command and the CA input buffers being fully operational can be up to seven and a half (7.5) nanoseconds. This longer powerdown exit time may create a performance penalty in the memory device.

Embodiments described herein provide systems, apparatuses, and methods for multiple powerdown modes. For example, a first powerdown mode powers down inactive CA input buffers completely (e.g., turn off). As such, exiting power down (i.e., the slow powerdown exit) requires a longer period of time to exit power down. A second powerdown mode powers down the inactive CA input buffers incompletely (i.e., a reduced operational state). The powerdown exit (i.e., the fast powerdown exit) requires a shorter period of time to exit power down (compared to the slow powerdown exit).

In one embodiment, inactive CA input buffers associated each inactive memory rank are shut down incompletely by putting the inactive CA input buffers into a low bias current state. The bias current in the inactive CA input buffers is reduced but is not zero, which enables the inactive CA input buffers to exit power down via the fast powerdown exit. When the inactive CA input buffers are in the low bias state, power consumption is lower compared to an active state of the CA input buffers but greater than when the CA input buffers are powered down completely.

The powerdown and exit modes can be indicated by a controller (e.g., the controller 102 of FIG. 1) in one of several ways. In one embodiment, a separate command can be provided by the controller to indicate which powerdown and exit mode is to be used. In another embodiment, a power down entry command can include one or more bits that are used to indicate which powerdown exit mode is to be used when exiting power down. For example, one or more CA bits in a power down entry command may be used to indicate which powerdown exit mode is to be used.

In other embodiments, a setting of a mode register (e.g., the mode register 230 of FIG. 2) may be used to indicate which powerdown exit mode is to be used when exiting power down. For example, a bit of a mode register may be set to indicate all powerdown exits are to be executed in one mode of the powerdown exit modes (e.g., a fast powerdown exit mode). In such embodiments, the other mode of the powerdown exit modes (e.g., the slow powerdown exit mode) is not available. In another embodiment, the mode register can be modified (e.g., reset) to switch between one powerdown exit mode to the other powerdown exit mode during operation of a memory device.

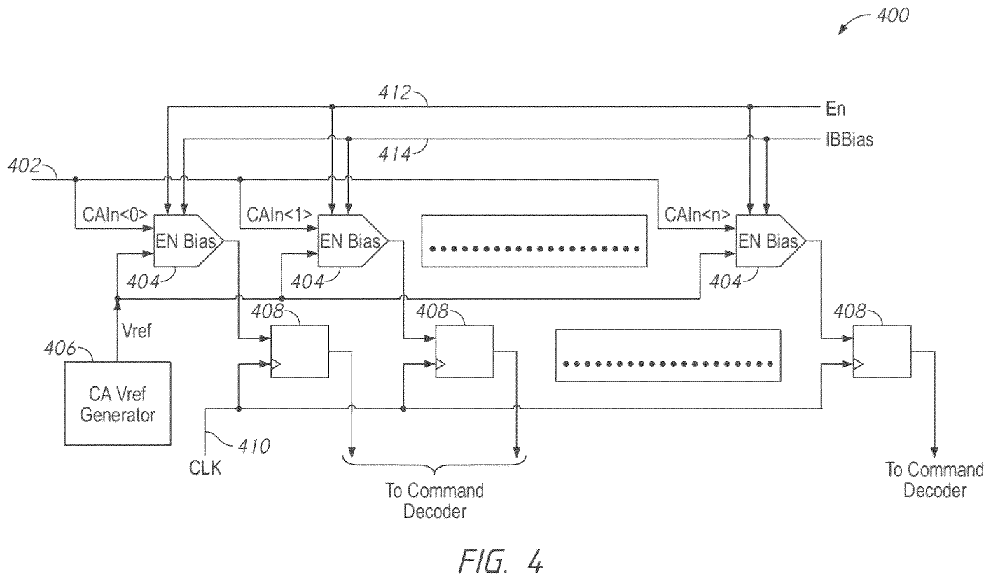

FIG. 4 illustrates a block diagram of certain features of an example CA input circuit 400 according to an embodiment of the disclosure. The example CA input circuit 400 may be implemented as the CA input circuit 215 of FIG. 2. As CA signals are received by a memory device (e.g., semiconductor device 200 of FIG. 2) on signal line 402, the CA signals may be provided to a buffer stage including CA input buffers 404 prior to being decoded by a command decoder (e.g., command decoder 215 of FIG. 2). The CA input buffers 404 may compare the CA signals to a reference voltage (Vref) output by a CA voltage reference generator 406. The CA voltage reference generator 406 may be within an element of the memory device or included in a separate power supply. The Vref signal and the CA signals are compared to determine the signal level (e.g., a “high” or “low” state) of each CA signal. Once the signal level of a CA signal is known, the CA signal may be sent from each CA input buffer 404 to a respective latch 408. Each latch 408 receives a clock signal CLK on signal line 410, and based on the clock signal, the latches 408 may control the timing of transmitting the CA signals to the command decoder.

An enable input buffer (En) signal provided on signal line 412 is received by each of the CA input buffers 404 at an enable input (EN). An input buffer bias (IBBias) signal provided on signal line 414 is also received by each of the CA input buffers 404 at a bias input (Bias). As will be described in more detail later, the enable input buffer signal and the input buffer bias signal are set to particular signal levels to place the CA input buffers into a low bias current state when the CA input buffers are to be powered down. The low bias current state incompletely powers down the inactive CA input buffers and enables the inactive CA input buffers to exit power down faster compared to when the inactive CA input buffers are powered down completely.

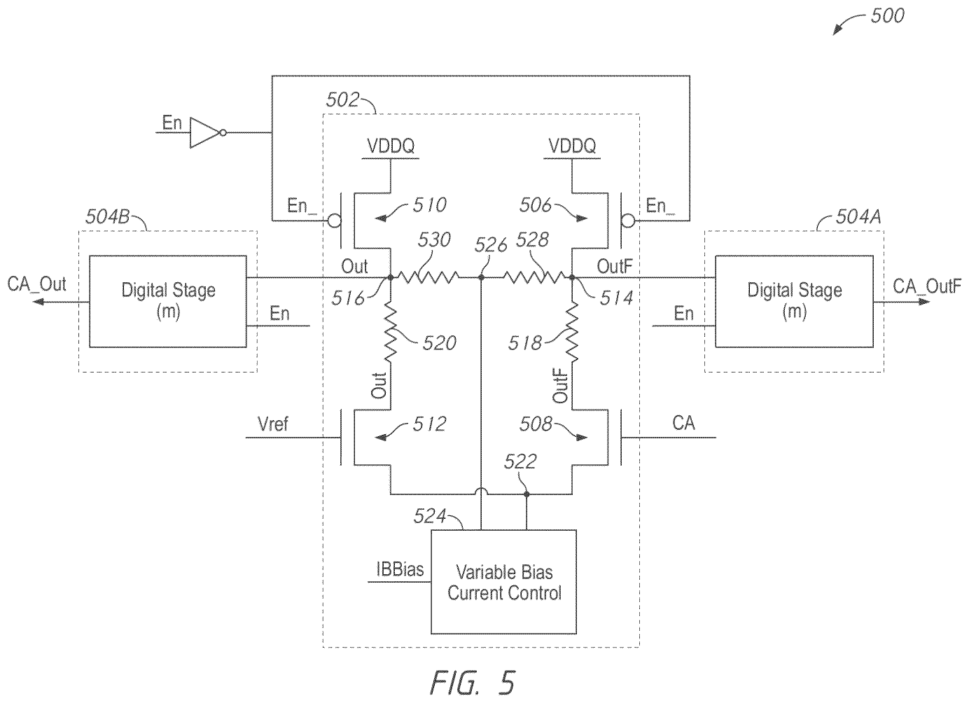

FIG. 5 illustrates a schematic diagram of an example CA input buffer 500 according to an embodiment of the disclosure. The example CA input buffer 500 includes an analog stage 502 and digital stages 504A, 504B. The analog stage 502 includes a first transistor 506 and a second transistor 508 connected in series. A third transistor 510 and a fourth transistor 512 are connected in series. The first transistor 506 and the second transistor 508 are connected in parallel with the third transistor 510 and the fourth transistor 512. In the illustrated embodiment, the first transistor 506 and the third transistor 510 are p-type transistors and the second transistor 508 and the fourth transistor 512 are n-type transistors. Other embodiments are not limited to this implementation.

In the analog stage 502, a first terminal of the first transistor 506 and a first terminal of the third transistor 510 are connected to a power supply (e.g., a voltage supply VDDQ). A second terminal of the first transistor 506 is connected to a first node 514. A second terminal of the third transistor 510 is connected to a second node 516. A first resistor 518 is connected between the first node 514 and a first terminal of the second transistor 508. A second resistor 520 is connected between the second node 516 and a first terminal of the fourth transistor 512. A second terminal of the second transistor 508 and a second terminal of the fourth transistor 512 are connected to a third node 522. The third node 522 is connected to a first input of a variable bias current control circuit 524. A fourth node 526 is connected to a second input of the variable bias current control 524. A third resistor 528 is connected between the first node 514 and the fourth node 526. A fourth resistor 530 is connected between the second node 516 and the fourth node 526.

The En signal is input into an inverter 532 to produce an enable bar (En_) signal. The enable bar signal is input at a gate of the first transistor 506 and a gate of the third transistor 510. A CA signal is input at a gate of the second transistor 508, and the Vref signal is input at a gate of the fourth transistor 512. In one embodiment, the En signal is controlled by a command decoder (e.g., the command decoder 215 of FIG. 2). The signal levels of the En signal depend on which powerdown mode is used.

The illustrated digital stages 504A, 504B each represent “m” digital stages, where m is equal to or greater than one (1). The digital stage 504A is connected to the first node 514 and the digital stage 504B is connected to the second node 516. A first differential output (OutF) of the analog stage 502 is output at the node 514 and received at a first input of the digital stage 504A. A second differential output (Out) of the analog stage 502 is output at the node 516 and received at a first input of the digital stage 504B. The En signal is input into a second input of the digital stages 504A, 504B. In one embodiment, the digital stages 504A, 504B are implemented as digital buffer circuits.

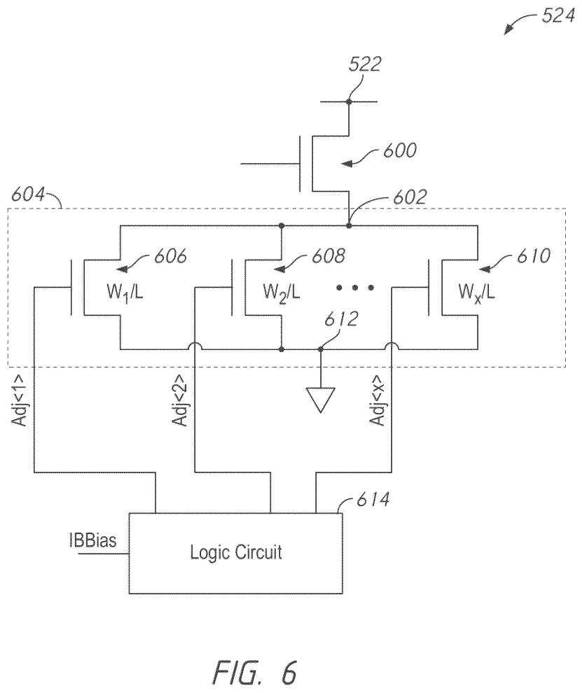

The variable bias current control circuit 524 is configured to set the bias current in the analog stage 502. A non-limiting nonexclusive example of a variable bias current control circuit 524 is shown and described in more detail in conjunction with FIG. 6.

The CA input buffer 500 is in an active state when the En signal and the IBBias signal are at an active signal level (e.g., a “1” or high). When the CA input buffer 500 is in the active state, the CA signal and the Vref signal are received and processed by the CA input buffer 500. The CA input buffer 500 is in the first powerdown mode with the slow powerdown exit when the En signal is at an inactive signal level (e.g., a “0” or low), which causes the CA input buffer 500 to turn off completely. The IBBias signal is not set (e.g., zero or a don't care state) and the CA signal and the Vref signal are received but are not processed by the CA input buffer 500.

The CA input buffer 500 is in the second powerdown mode with the fast powerdown exit mode when the En signal is at the active signal level and the IBBias signal is at an inactive signal level (e.g., “0” or low). The CA signal and the Vref signal are received but are not processed when the CA input buffer 500 is in the second powerdown mode. The low bias current can run through the analog stage 502 because the CA input buffer 500 will not be used. The smaller bias current causes the voltage levels at the first resistor 518, the second resistor 520, the third resistor 528, and the fourth resistor 530 to be at levels that are at or close to the voltage levels the first resistor 518, the second resistor 520, the third resistor 528, and the fourth resistor 530 would be at when the CA input buffer 500 is biased fully. Since the voltage levels at the first resistor 518, the second resistor 520, the third resistor 528, and the fourth resistor 530 are at or close to the fully biased voltage levels, the CA input buffer 500 can recover and be capable of full operation faster when the CA input buffer 500 exits power down.

However, as noted earlier, the CA signal is still received and can toggle over time when the CA input buffer 500 is in the low bias current state. The toggling of the CA signal may cause transitions at the first and the second outputs (OutF and Out) at the first node 514 and the second node 516, respectively. The transitions at the first output OutF and at the second output Out are received by the digital stages 504A, 504B, respectively and output to other components in the memory device. The other components can consume power needlessly based on the received transitions (e.g., power consumption based on alternating current (AC) signals). To prevent this unnecessary consumption of power, the digital stages 504A, 504B are forced to a known state to block transmission of the transitions to the other components. In one embodiment, the digital stages 504A, 504B are forced into a state where the outputs of the digital stages 504A, 504B are direct current (DC) signals. In a non-limiting nonexclusive example, the digital stages may be forced to a known state by an “OR” function with the En_signal and an IBBias bar (IBBias_) signal as inputs to the OR function. The IBBias_signal is complementary to the IBBias signal. When the CA input buffer is disabled completely and the En_signal level is at a first signal level (e.g., “1” or high), the digital stages can be disabled and set to drive the known state.

In this instance, the inactive CA input buffer exits power down using the slow powerdown exit. Alternatively, when the CA input buffer is disabled incompletely and the IBBias_signal level is at the first signal level (e.g., “1” or high), the digital stages can be disabled and set to drive the known state. The inactive CA input buffer exits power down using the fast powerdown exit.

FIG. 6 illustrates a schematic diagram of an example implementation of the variable bias current control circuit 524 shown in FIG. 5 according to an embodiment of the disclosure. A first terminal of a transistor 600 is connected to the third node 522 and a second terminal of the transistor 600 is connected to a node 602. A current control circuit 604 is connected to the node 602. In the illustrated embodiment, the current control circuit 604 includes an “x” number of transistors 606, 608, 610, where x can be equal to or greater than one (1). The transistors 606, 608, 610 are connected in parallel between the node 602 and a node 612. The node 612 is connected to a reference voltage, such as ground. An adjustable signal Adj<1>, Adj<2>, Adj<x> is received at a respective gate of the transistors 606, 608, 610.

The ratios of the widths (W1, W2, Wx) and the length (L) of the transistors 606, 608, 610 can vary in some embodiments. The adjustable signals Adj<1>, Adj<2>, Adj<x> effectively modulate the total width of the current control circuit 604. The adjustable signals Adj<1>, Adj<2>, Adj<x> are configured to adjust the effective size of the current control circuit 604. A logic circuit 614 receives the IBBias signal and outputs the adjustable signals Adj<1>, Adj<2>, Adj<x>. The logic circuit 614 controls the signal levels of the adjustable signals Adj<1>, Adj<2>, Adj<x> based on the signal level of the IBBias signal. In one embodiment, a command decoder (e.g., the command decoder 215 of FIG. 2) controls the signal level of the IBBias signal based on which powerdown mode is used.

In a non-limiting nonexclusive example, the number of the Adj<x> signals that are asserted (e.g., “1” or high) is based on the signal level of the IBBias signal. A first number of Adj<x> signals are asserted when the signal level of the IBBias signal is at the first signal level (e.g., “1” or high). A second number of Adj<x> signals are asserted when the IBBias signal level is at a second signal level (e.g., “0” or low), where the second number of Adj<x> signals is less than the first number of Adj<x> signals. The assertion of the smaller second number of Adj<x> signals reduces the bias current through the CA input buffer. Combinational logic can be used to determine which Adj<x> signals are asserted depending on the signal level of the IBBias signal. In the illustrated embodiment, the Adj<x> signals are digital signals (e.g., signal levels at VDDQ or VSS), but other embodiments are not limited to this implementation. The signal levels of the Adj<x> signals may be at an analog voltage level in other embodiments.

For high-speed operation, the bias current is increased by activating more transistors 606, 608, 610 using the adjustable signals (Adj<n>). In the low bias current state, the enable bar (En_) signal is held low to keep the CA input buffer enabled, but the bias current is reduced by deactivating some of the transistors 606, 608, 610 using the adjustable signals (Adj<n>). The differential outputs of the analog stage (e.g., the analog stage 502 of FIG. 5) remain near the high speed operation voltage levels, so recovery from the low bias current state to the full bias current state is faster compared to the complete power down of the CA input buffer (e.g., complete power down using the enable bar signal).

FIG. 7 illustrates an example timing diagram for a slow powerdown exit according to an embodiment of the disclosure. At time t0, the chip select signal (CS_n) transitions to a low state (e.g., a “0”) and the PDE command is received at the rising edge of the clock clk (e.g., system clocks CK_t and/or CK_c) following time to, which causes the CA input buffers in the inactive memory rank(s) to power down completely (i.e., turn off). The chip select signal transitions back to a high state (e.g., “1”) after time to. The amount of time that the CA input buffers enter power down and remain powered down is tPDs (the time between “c” and “d”). At time t1, the chip select signal (CS_n) transitions to a low state for the inactive memory rank(s) and a PDX command is received at the rising edge of the clock clk following time t1 to cause the CA input buffers to exit power down and become operational. The amount of time for the CA input buffers to exit power down is tXPs (the time between “d” and “e”).

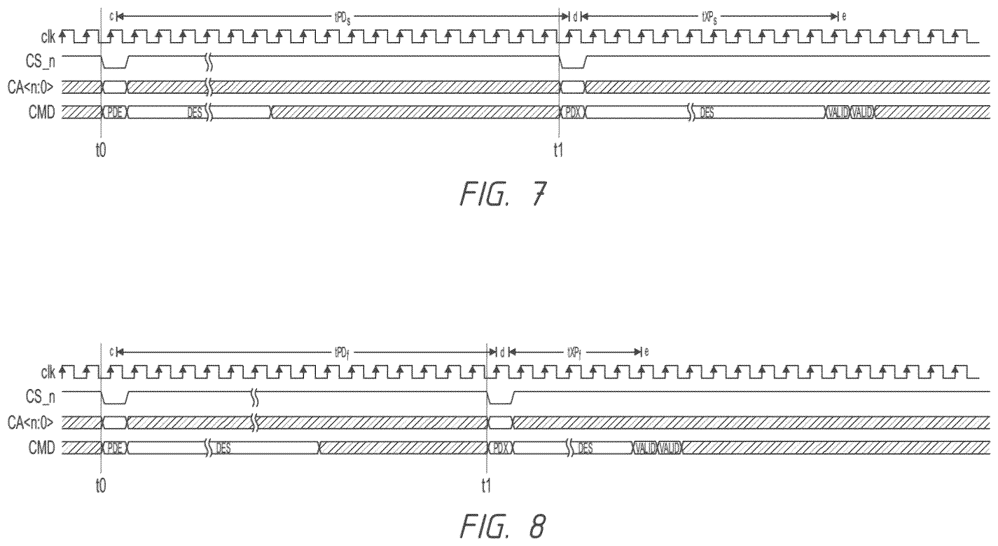

FIG. 8 illustrates an example timing diagram for a fast powerdown exit according to an embodiment of the disclosure. At time to, the chip select signal (CS_n) transitions to an active level (e.g., a low or “0”) for the inactive memory rank(s) and the PDE command is received at the rising edge of the clock clk (e.g., system clocks CK_t and or CK_c) following time t0, which causes the CA input buffers associated with the inactive memory rank(s) to power down incompletely (e.g., via the low bias current state). The chip select signal transitions back to an inactive level (e.g., a high or “1”) after time t0. The amount of time that the CA input buffers enter power down and remain powered down is tPDf (the time between “c” and “d”). At time t1, the chip select signal (CS_n) transitions to the active state for the inactive memory rank(s) and the PDX command is received at the rising edge of the clock clk following time t1 to cause the inactive CA input buffers to exit power down and become operational. The amount of time for the inactive CA input buffers to exit power down is tXPf (the time between “d” and “e”).

Comparing the timing diagram of FIG. 7 to the timing diagram of FIG. 8, the time tXPr in the fast powerdown exit is less than the time tXPs in the slow powerdown exit. This time reduction is based at least in part on the delays associated with powering up the completely inactive CA input buffers. Additionally, the time tPDf in the fast powerdown exit is less than the time tPDs in the slow powerdown exit. This additional time reduction is based at least in part on placing the inactive CA input buffers in the low bias current state, where the internal voltage levels are at higher voltage levels compared to when the inactive CA input buffers are turned off completely. The higher voltage levels enable the inactive CA input buffers to exit power down more quickly. Due to the reductions in the tPD time period and the tXPr time period, the overall latency penalty associated with the fast powerdown exit is less than the overall latency penalty of the slow powerdown exit. A lower latency penalty can improve the performance of a memory device.

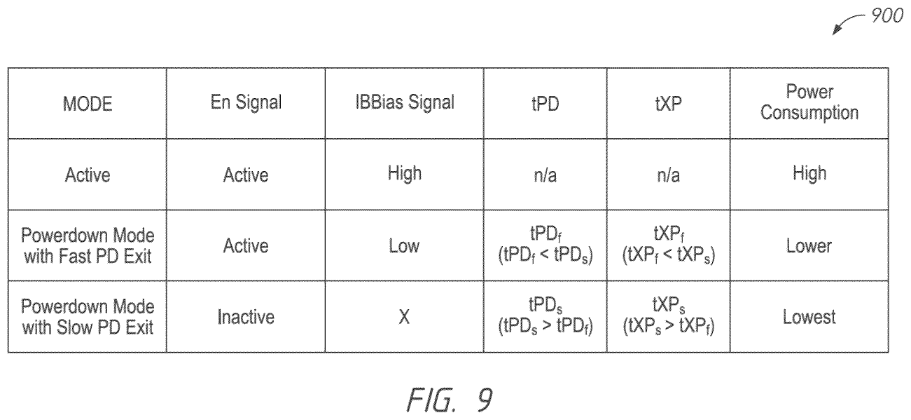

FIG. 9 illustrates a table 900 that lists characteristics of an active mode, a powerdown mode with a fast powerdown exit, and a powerdown mode with a slow powerdown exit for a CA input buffer according to an embodiment of the disclosure. For the active mode, the CA input buffers are turned on and active when the signal level of the

En signal is at an active signal level (e.g., “1” or high) and the IBBias signal is at an active signal level (e.g., “1” or high). The time periods tPD and tXP are not applicable because the CA input buffers are not powered down, and the power consumption of a memory device is high. In the powerdown mode with fast powerdown exit, the CA input buffers are incompletely turned off (e.g., in the low bias current state) when the signal level of the En signal is at the active signal level and the IBBias signal level is at the inactive signal level (e.g., “0” or low). The time periods tPD_{f} and tXP_{f} are less than the time periods tPDs and tXPs, respectively, and the power consumption of a memory device is lower than the power consumption in the active mode. In the powerdown mode with slow powerdown exit, the CA input buffers are powered down completely when the signal level of the En signal is at an active signal level (e.g., “0” or low) and the IBBias signal is zero or in a don't care state (represented by X). The time periods tPDs and tXPs are greater than the time periods tPD_{f} and tXP_{f}, respectively, and the power consumption of a memory device is lowest compared to the power consumption in the active mode and in the powerdown mode with fast powerdown exit.

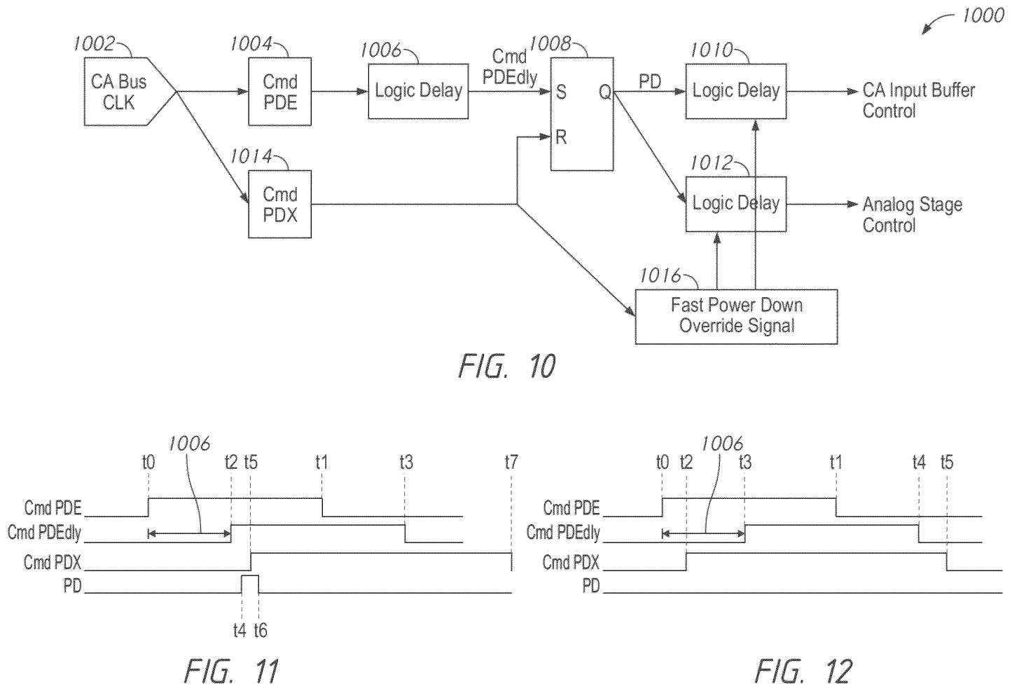

FIG. 10 illustrates a process flow diagram 1000 for a power down entry command and a power down exit command according to an embodiment of the disclosure. Three process paths are shown in FIG. 10, and the process paths are based on the CA bus clock (CLK) signal 1002 (e.g., clocks CK_t and/or CK_c). The first process path is the PDE command path, which includes receipt of the PDE command (Cmd PDE) 1004, a logic delay 1006, a latch 1008 (e.g., an SR latch), and logic delays 1010, 1012. The second process path is the first powerdown mode with slow powerdown exit, which includes receipt of the PDX command (Cmd PDX) 1014 and the latch 1008. The third process path is the second powerdown mode with fast powerdown exit, which includes the PDX command (Cmd PDX) 1014, the latch 1008, and a fast power down override signal circuitry 1016.

When the PDE command 1004 is received, a logic delay 1006 occurs based at least in part on the time needed to decode the PDE command. A delayed PDE command (CmdPDEdly) is received by the set input of the latch 1008 to set the set input to a first state (e.g., a high or “1” state). The latch 1008 holds the PDE command for internal circuit control.

When a PDX command 1014 is received, and the slow powerdown exit is to be used, the latch 1008 is reset via the reset input. The logic delays 1010, 1012 are based in part of the processing and transmission of the control signals for control of the CA input buffer(s) and the analog stage of the CA input buffer(s). In this instance, the set and the reset of the latch 1008 are not in contention because the set and the reset are separated by the tPDs time period (FIG. 7), which in some embodiments is defined in a product specification (e.g., the DDR5 SDRAM specification by the JEDEC Solid State Technology Association).

However, when a PDX command 1014 is received and the fast powerdown exit is to be used, the set and the reset of the latch 1008 can be in contention because the latch 1008 may be reset while the set of the latch 1008 is still executing. The set of the latch 1008 may still be executing due to the logic delay 1006 and to a delay within the latch 1008. Accordingly, the fast powerdown exit override signal circuitry 1016 is used with the fast powerdown exit. The fast powerdown exit override signal circuitry 1016 includes one or more circuits (e.g., circuits with look ahead logic) to override the control signals associated with powering down and turns the control signals back on for the fast powerdown exit. In one embodiment, the look ahead logic implements the fastest command decoding with a minimal amount of buffering and no decoding logic. The fast powerdown exit override signal circuitry 1016 transmits the signals associated with the fast powerdown exit to the end of the power down logic to enable the inactive CA input buffers to power up quickly. The control signals for the fast powerdown exit are turned on once the set and reset of the latch 1008 has cleared out.

FIG. 11 illustrates a first timing diagram for a PDE command and a fast power down exit according to an embodiment of the disclosure. The timing diagram includes plots for the PDE command signal (Cmd PDE), the delayed PDE command signal (Cmd PDEdly), the PDX command signal (Cmd PDX), and a power down signal (PD). The PDE command signal becomes active at time t0 and remains at an active signal level (e.g., high or “1”) until time t1. The delayed PDE command signal becomes active at time t2 to set the set input of the latch 1008 to the first state (e.g., a high or “1” state). The time period t0-t2 represents the amount of time of the logic delay 1006 (FIG. 10). At time t4, the PD signal becomes active and the memory rank(s) enter power down. The PDX command signal becomes active at time t5. Thus, the memory rank(s) enters power down briefly before the PDX command resets the latch 1008. In the illustrated embodiment, the latch 1008 is designed such that reset has priority over set. Since the delayed PDE command signal and the PDX signal are both asserted at and after time t5, the reset priority for the latch 1008 will cause the inactive memory rank(s) to exit power down.

FIG. 12 illustrates a second timing diagram for a PDE command and a fast power down exit according to an embodiment of the disclosure. The timing diagram includes plots for the PDE command (Cmd PDE), the delayed PDE command (Cmd PDEdly), the PDX command (Cmd PDX), and the PD signal. The PDE command becomes active at time to. The PDX command becomes active at time t2, before the delayed PDE command is received at the latch 1008 at time t3. In this instance, the memory rank(s) never enters power down. In both FIG. 11 and FIG. 12, the PDX command signal is asserted for a sufficient amount of time (times t5 to t7 in FIG. 11 and times t2 to t5 in FIG. 12) to envelop the delayed PDE command signal, which prevents the latch 1008 from being set when the PDX command signal transitions low (time t7 in FIG. 11 and time t5 in FIG. 12).

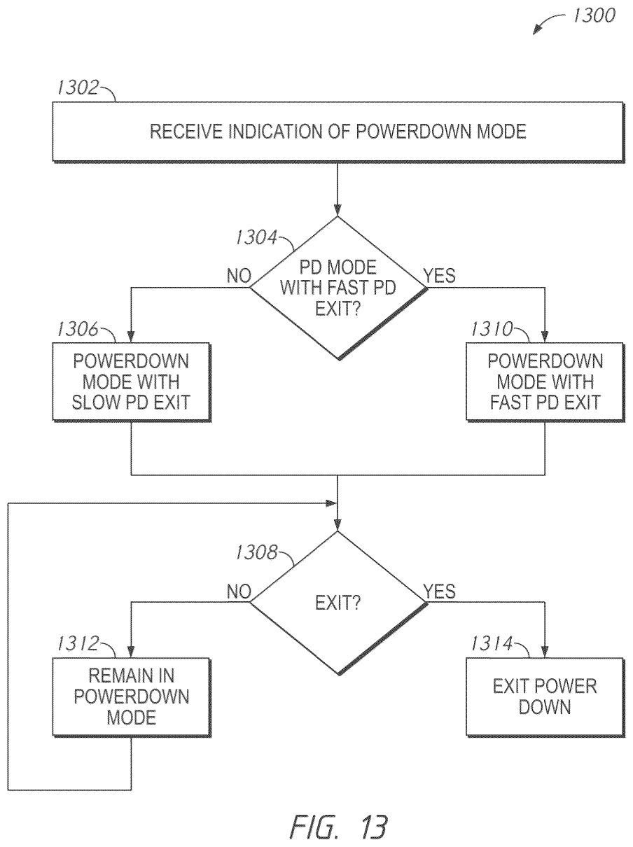

FIG. 13 illustrates a flowchart of an example method 1300 of operating a memory device according to an embodiment of the disclosure. In one embodiment, the memory device is a memory module that includes multiple memory ranks. Initially, an indication of a powerdown mode is received at block 1302. In one example, a host device may transmit a command to a controller that will require a memory rank that is currently inactive to be accessed. The controller can responsively transmit a PDX command to that memory rank.

As described earlier, the indication of the powerdown mode may be received in one of several ways. In one embodiment, a separate command can be provided by a command decoder (e.g., the command decoder 215 of FIG. 2) to indicate which powerdown mode is to be used. In another embodiment, a PDE command can include one or more bits that are used to indicate which powerdown mode is to be used. In other embodiments, a setting of a mode register (e.g., the mode register 230 of FIG. 2) may be used to indicate which powerdown mode is to be used.

At block 1304, a determination is made as to whether a powerdown mode with fast powerdown exit was indicated at block 1302. If a determination is made that the powerdown mode with fast powerdown exit was not indicated, the method passes to block 1306 where the powerdown mode with slow powerdown exit is executed and the inactive CA input buffers power down completely and will exit power down via the slow powerdown exit. However, when a determination is made at block 1304 that the powerdown mode with fast powerdown exit was indicated, the method continues at block 1310 where the powerdown mode with fast powerdown exit is executed and the inactive CA input buffers power down incompletely (e.g., reduced operational state such as the low bias current state) and will exit power down via the fast powerdown exit. From blocks 1306 and 1310, the method proceeds to block 1308.

At block 1308, a determination is made as to whether a PDX command is received. If a determination is made that the PDX command has not been received, the method passes to block 1312 where the inactive CA input buffers remain powered down. The method then returns to block 1308 and waits until PDX command is received. When a determination is made at block 1308 that the PDX command is received, the method continues at block 1314 where the inactive CA input buffers exit power down via the indicated fast powerdown exit or slow powerdown exit.

The foregoing description, for purposes of explanation, uses specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An apparatus, comprising:
a memory rank; and
a command and address (CA) input buffer associated with the memory rank,
wherein the CA input buffer is configured to be powered down in one of multiple powerdown modes.

2. The apparatus of claim 1, wherein the one of multiple powerdown modes comprises a complete power down.

3. The apparatus of claim 1, wherein the one of multiple powerdown modes comprises an incomplete power down.

4. The apparatus of claim 3, wherein the incomplete power down comprises a low bias current state.

5. The apparatus of claim 1, wherein the CA input buffer comprises an analog stage and a plurality of digital stages.

6. The apparatus of claim 5, wherein the analog stage comprises a variable bias current control circuit configured to control a level of bias current in the analog state.

7. The apparatus of claim 5, wherein the analog stage comprises:
a first transistor connected in series with a second transistor;
a third transistor connected in series with a fourth transistor, where the first and the second transistors are connected in parallel with the third and the fourth transistors; and
a variable bias current control circuit connected to the second and the fourth transistors.

8. The apparatus of claim 5, wherein a first digital stage of the plurality of digital stages is connected to a first output of the analog stage and a second digital stage of the plurality of digital stages is connected to a second output of the analog stage.

9. The apparatus of claim 5, wherein each digital stage comprises a digital buffer.

10. The apparatus of claim 1, wherein the CA input buffer is configured to be placed in the one of multiple powerdown modes based on a power down entry command.

11. The apparatus of claim 1, wherein the CA input buffer is configured to be placed in the one of multiple powerdown modes based on a setting of a mode register.

12. The apparatus of claim 1, wherein the memory rank is one of a plurality of memory
ranks that are included on a memory module.

13. A method, comprising:
receiving an indication of a powerdown mode for a memory rank;
based on a determination that the indication indicates a powerdown mode with a fast powerdown exit, incompletely powering down one or more command address (CA) input buffers in the memory rank; and
exiting the power down via the fast powerdown exit to activate the one or more command address input buffers.

14. The method of claim 13, wherein incompletely powering down the one or more CA input buffers comprises placing the one or more CA input buffers in a low bias current state.

15. The method of claim 13, further comprising based on a determination that the indication indicates a powerdown mode with a slow powerdown exit, powering down the CA input buffers completely.

16. The method of claim 13, wherein receiving an indication of the powerdown mode for the memory rank comprises receiving a power down entry command that includes one or more bits that provide the indication of the powerdown mode.

17. The method of claim 13, wherein receiving an indication of the powerdown mode for the memory rank comprises receiving information stored in a mode register, the information providing the indication of the powerdown mode.

18. A controller configured to transmit commands to a memory module, the commands comprising:
a power down entry command configured to power down one or more command address (CA) input buffers in a memory rank of the memory module in one of two powerdown modes, wherein a first powerdown mode is configured to exit power down in a slow powerdown exit and a second powerdown mode is configured to exit power down in a fast powerdown exit; and
a power down exit command configured to cause the memory rank to exit the power down in either the slow powerdown exit or the fast powerdown exit.

19. The controller of claim 18, wherein the first powerdown mode powers down the one or more CA input buffers completely.

20. The controller of claim 18, wherein the second powerdown mode powers down the one or more CA input buffers incompletely by placing the one or more input buffers in a low bias current state.
